(19) United States
(12) Patent Application Publication
(10) Pub. No.: US 2008/0257087 A1
(43) Pub. Date: Oct. 23, 2008

(54) Position Feedback Device for an Actuator

(76) Inventor: Chien-Chih CHEN, Taichung Industrial Park (TW)

Correspondence Address: Dr. BANGER SHIA, 102 Lindencrest Ct., Sugar Land, TX, 77479-5201, US

(21) Appl. No.: 11/738,461

(22) Filed: Apr. 20, 2007

(51) Int. Cl. F16H 55/22

(52) U.S. Cl. 74/425

(57) ABSTRACT

A position feedback device for an actuator is mounted on a housing of the actuator is directly driven to rotate by the screw of the actuator, such that the position feedback device can reflect the travel length of the actuator, and the maximum travel length of the actuator that the position feedback device can reflect is also increased, further, the structure of the screw of the actuator for driving the position feedback device is simplified.

### BACKGROUND OF THE INVENTION

1. Field of the Invention

The present invention relates to a position feedback device for an actuator, and more particularly to a position feedback device, wherein the maximum travel length of the actuator that the position feedback device can reflect can be increased, and the structure of the screw of the actuator for driving the position feedback device can also be simplified.

2. Description of the Prior Art

Actuators are usually used as a drive device, one of the actuators achieves the drive function by utilizing a motor to rotate a screw, and is usually used on the sickbed lifting mechanism or other extending and retracting mechanisms.

When the conventional actuator is in use, its travel length and position are not required to be precisely controlled. However, with the growing precision of science, when the actuator drives a mechanism to move, the movement of the mechanism must be controlled precisely, and accordingly, the travel length of the actuator must also be controlled precisely. Therefore, a position feedback device A was developed and appeared on the market, which is to be used with a screw B, as shown in FIG. 1. The position feedback device A comprises a rotary shaft A1 with a spur gear A2, and rotating the rotary shaft A1 can change the resistance of the position feedback device A. one end of the screw B is coaxially connected with a spur gear B1 to be meshed with the spur gear A2 of the position feedback device A. When the screw B rotates, it can synchronously drive the rotary shaft A1 of the position feedback device A, so as to change the resistance of the position feedback device A. After the amount of resistance change of the position feedback device A is known, the rotation angle of the rotary shaft A1 can also be known, and then the rotation angle of the screw B can be calculated from the gear ratio between the two spur gears A2 and B1, and thus the travel length of the actuator and the position of the screw B can be worked out.

However, since the position feedback device A for calculating the rotation angle of the screw B is rotated by meshing the spur gear A2 with the spur gear B1, the reduction ratio will not be high. Plus the position feedback device A has limitation in rotation, therefore, the measurable maximum travel length of the actuator is not great. In addition, many screws B of the actuator do not have space at their ends to accommodate the spur gear B1, and thus the position feedback device A cannot be used.

Therefore, another position feedback device A appeared on the market, as shown in FIG. 2, which is meshed with the screw B through a medium A3. The medium A3 has various sizes and types, we just take one of them as an example. The medium A3 has an input end A31 to be engaged with the screw B and an output end A32 to be engaged with the spur gear A2. The screw B drives the rotary shaft A1 to rotate through the medium A3, The position feedback device A can detect the rotation angle of the screw B, and accordingly, the travel length of the actuator is known. The best advantage of this structure is that the position feedback device A can be positioned at any position on the screw B without the problem of space limitation.

However, such a device must use the medium A3, it not only increases the cost, the structure is complicated, but also the maintenance is difficult. Further, it also has the problem of low reduction ratio.

The present invention has arisen to mitigate and/or obviate the afore-described disadvantages.

### SUMMARY OF THE INVENTION

The primary objective of the present invention is to provide a position feedback device for an actuator, wherein the position feedback device is driven directly by a screw of the actuator, so as to increase the maximum travel length of the actuator that the position feedback device can reflect, and simplify the structure of the screw of the actuator for driving the position feedback device.

A position feedback device for an actuator in accordance with the present invention comprises a worm gear to be connected with a screw in the actuator. The screw of the actuator directly drives the worm of the position feedback device to rotate, the rotation angle of the screw is calculated from the rotation angle of the worm gear, and then the rotation angle of the screw is transmitted outward by the position feedback device, and thus travel length and position of the actuator can be known.

Since the worm of the position feedback device of the present invention is rotated by the screw of the actuator, the reduction ratio will be increased substantially. If the rotation angle of the rotary shaft of the position feedback device is the same, the travel length of the actuator that the position feedback device of the present invention can reflect is relatively large as compared with the conventional structure. Therefore, it can increase the maximum travel length of the actuator that the position feedback device can reflect.

Since the worm gear of the position feedback device of the present invention is directly driven by the screw of the actuator without using any additional medium structure, the structure of the present invention is simplified.

Further, the worm gear of the position feedback device can be directly engaged with the screw of the actuator, or the screw of the actuator is connected with a threaded sleeve, and outer threads of the threaded sleeve correspond to threads of the screw, the threaded sleeve of the screw is engaged with the worm gear of the position feedback device.

In addition, the position feedback device is a variable resistor and used to reflect the rotation angle of the screw of the actuator, its resistance can be changed by rotating the rotary shaft. Then the rotation angle of the rotary shaft can be calculated from the amount of resistance change. And finally, the travel length and the position of the actuator can be worked out.

### BRIEF DESCRIPTION OF THE DRAWINGS

FIG. 1 is a perspective view of a conventional position feedback device;

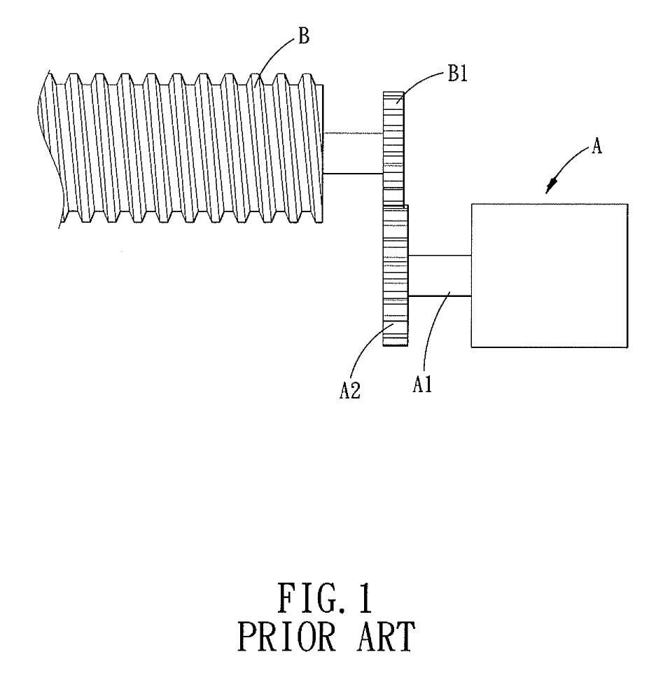

FIG. 2 is a perspective view of a conventional position feedback device with a medium structure;

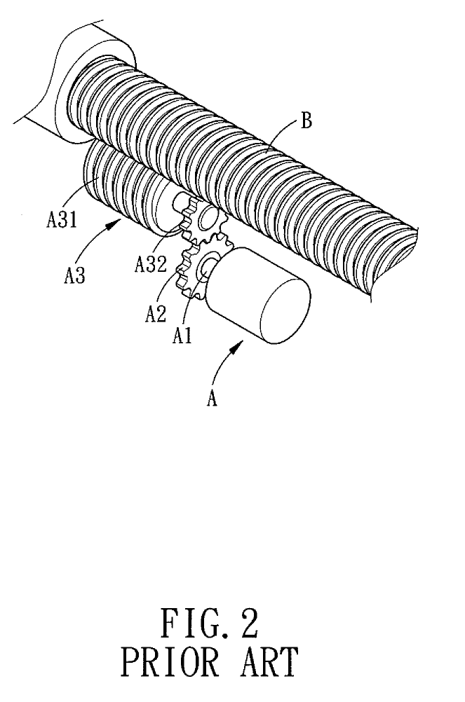

FIG. 3 is a perspective view of a position feedback device in accordance with the present invention;

FIG. 4 is a perspective view of showing the position feedback device in accordance with the present invention, wherein the screw is rotating a worm gear; and

FIG. 5 is a perspective view of showing the position feedback device in accordance with another embodiment of the present invention, wherein the screw is connected with a threaded sleeve.

### DETAILED DESCRIPTION OF THE PREFERRED EMBODIMENTS

The present invention will be more clear from the following description when viewed together with the accompanying drawings, which show, for purpose of illustrations only, the preferred embodiment in accordance with the present invention.

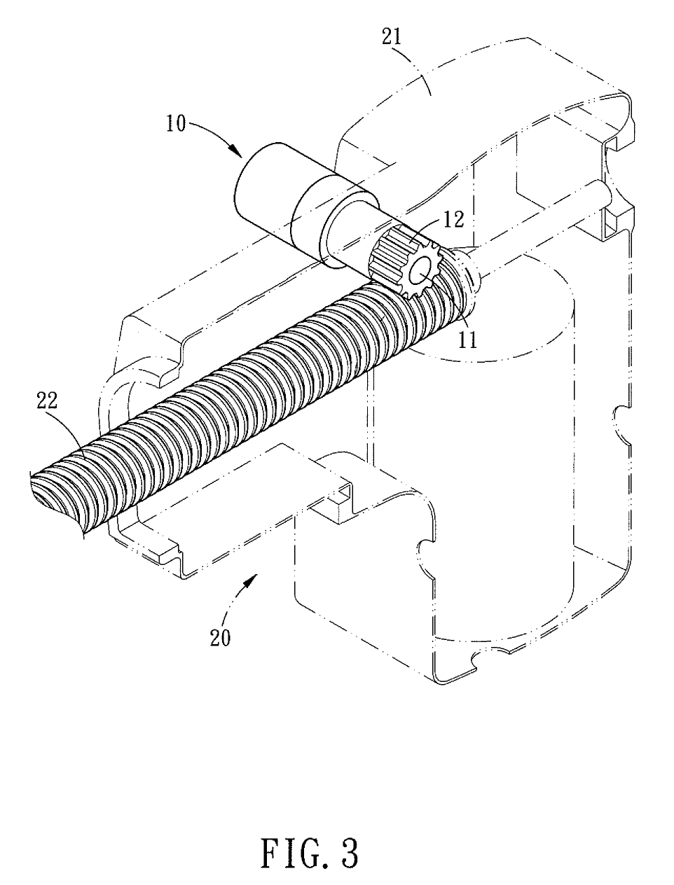

Referring to FIG. 3, a position feedback device 10 for an actuator in accordance with the present invention is mounted on a housing 21 of the actuator 20 and comprises a rotary shaft 11. Mounted on the rotary shaft is a worm gear 12 that passes through the housing 21 of the actuator 20 and is meshed with a screw 22 of the actuator 20.

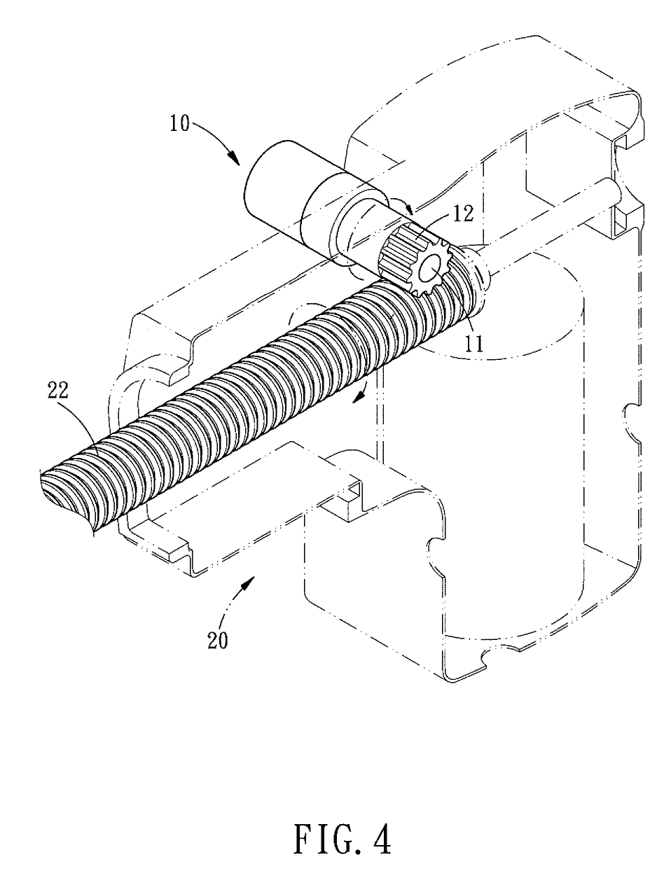

When the screw 22 of the actuator 20 rotates, it can synchronously drive the rotary shaft 11 of the position feedback device 10 to rotate through the worm gear 12, as shown in FIG. 4. From the rotation angle of the rotary shaft 11 and the reduction ratio between the worm gear 12 and the screw 22, we can know the rotation angle of the screw 22 of the actuator 20, and then the rotation angle of the screw 22 is transmitted outward by the position feedback device 10.

If the position feedback device 10 is a variable resistor, its resistance can be changed by rotating the rotary shaft 11. Then the rotation angle of the rotary shaft 11 can be known from the amount of resistance change. And then the rotation angle of the screw 22 can be known from the rotation angle of the rotary shaft 11 and the reduction ratio between the worm gear 12 and the screw 22. And finally, the travel length and the position of the actuator can be worked out.

Since the worm 10 of the position feedback device 10 of the present invention is rotated by the screw 22 of the actuator 20, the reduction ratio will be increased substantially. Under the condition that the rotation angle of the rotary shaft 11 of the position feedback device 10 is the same, the higher the reduction ratio between the position feedback device 10 and the actuator 20, the greater the rotation angle of the screw 22 of the actuator 20 that the position feedback device 10 can reflect. Therefore, increasing the reduction ratio can increase the maximum travel length of the actuator 20 that the position feedback device 10 can reflect or measure.

The worm gear 12 of the position feedback device of the present invention is directly driven by the screw 22 of the actuator 20 without using any additional medium structures, therefore, the structure of the present invention is simplified.

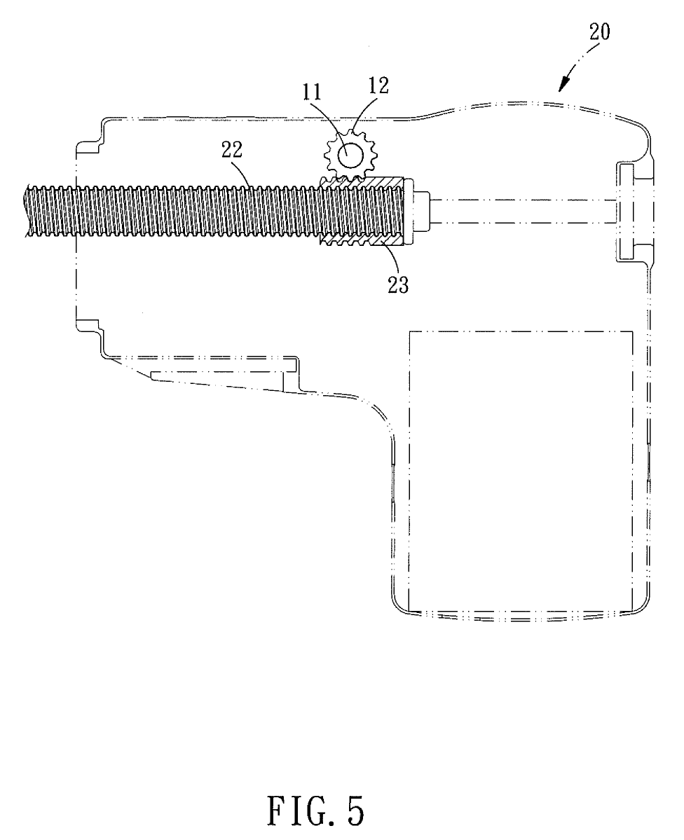

In addition, the connection between the position feedback device 10 and the actuator 20 can also be achieved by other methods as shown in FIG. 5. The screw 22 of the actuator 20 is connected with a threaded sleeve 23, and the outer threads of the threaded sleeve 23 correspond to the threads of the screw 22. The threaded sleeve 23 of the screw 22 is engaged with and serves to drive the worm gear 12 of the position feedback device 10. And such arrangements can also achieve the same functions and advantages as the previous embodiment.

To summarize, the position feedback device in accordance with the present invention is mounted on an actuator and is driven directly by a screw of the actuator, such that the position feedback device can reflect the travel length of the actuator, and the maximum travel length of the actuator that the position feedback device can reflect is also increased, further, the structure of the screw of the actuator for driving the position feedback device is simplified.

While we have shown and described various embodiments in accordance with the present invention, it is clear to those skilled in the art that further embodiments may be made without departing from the scope of the present invention.

What is claimed is:

1. A position feedback device for an actuator being mounted on a housing of the actuator and comprising a worm gear to be connected with a screw of the actuator; characterized in that:
the screw of the actuator directly drives the worm of the position feedback device to rotate, rotation angle of the worm gear is used to calculate rotation angle of the screw, and then the rotation angle of the screw is transmitted outward by the position feedback device, and thus travel length and position of the actuator are known.

2. The position feedback device for an actuator as claimed in claim 1, wherein the screw of the actuator is meshed with the worm gear of the position feedback device.

3. The position feedback device for an actuator as claimed in claim 1, wherein the screw of the actuator is connected with a threaded sleeve, and outer threads of the threaded sleeve correspond to threads of the screw, the threaded sleeve of the screw is engaged with the worm gear of the position feedback device.

4. The position feedback device for an actuator as claimed in claim 1, wherein the position feedback device is a variable resistor.

5. The position feedback device for an actuator as claimed in claim 2, wherein the position feedback device is a variable resistor.

6. The position feedback device for an actuator as claimed in claim 3, wherein the position feedback device is a variable resistor.
